(19) United States
(12) Patent Application Publication
(10) Pub. No.: US 2024/0329373 A1
(43) Pub. Date: Oct. 3, 2024

(54) DISPLAY DEVICE

(71) Applicant: Panasonic Automotive Systems Co., Ltd., Kanagawa (JP)

(72) Inventors: Hirofumi HOSHIDA, Kanagawa (JP); Kenji NAGATOMI, Osaka (JP); Norihiro IMAMURA, Osaka (JP); Eiji NAGASAKI, Osaka (JP)

(73) Assignee: Panasonic Automotive Systems Co., Ltd., Kanagawa (JP)

(21) Appl. No.: 18/742,368

(22) Filed: Jun. 13, 2024

Related U.S. Application Data
(63) Continuation of application No. PCT/JP2022/030665, filed on Aug. 10, 2022.

(30) Foreign Application Priority Data
Dec. 27, 2021 (JP) 2021-211854
May 16, 2022 (JP) 2022-080064

(51) Int. Cl. G02B 17/06; B60R 1/12

(52) U.S. Cl. CPC G02B 17/06; B60R 1/12; B60R 2001/1215

(57) ABSTRACT

A display device includes: a display element; an optical element including opposing first and second surfaces; and a casing. When the optical element placed such that its height direction matches the vertical direction is viewed in a cross section including the vertical direction, and t1/t2 defines a thickness ratio, where t1 and t2 represent a thickness of upper and lower ends of the optical element, respectively, in a reference direction parallel to a normal line from an origin of the second surface, a value of the thickness ratio at which the width of the display element is equal to a width of the optical element is defined as an upper limit, and a value of the thickness ratio that is equal to a depth of the casing when the thickness ratio is equal to the upper limit, and less than the upper limit is defined as a lower limit.

### CROSS REFERENCE TO RELATED APPLICATIONS

This is a continuation application of PCT International Application No. PCT/JP2022/030665 filed on Aug. 10, 2022, designating the United States of America, which is based on and claims priority of Japanese Patent Application No. 2021-211854 filed on Dec. 27, 2021, and Japanese Patent Application No. 2022-080064 filed on May 16, 2022.

### FIELD The present disclosure relates to a display device.

### BACKGROUND

In recent years, display devices for displaying images are known. For example, as an example of a display device, Patent Literature (PTL) 1 discloses a display device that includes a display, a half mirror that reflects an image displayed on the display, and a concave mirror that reflects the image reflected off by the half mirror.

### CITATION LIST

### Patent Literature

PTL 1: Japanese Unexamined Patent Application Publication No. 2017-210229

### SUMMARY

However, the display device according to PTL 1 can be improved upon.

In view of this, the present disclosure provides a display capable of improving upon the above related art.

A display device according to an aspect of the present disclosure includes: a display element that includes a display surface; an optical element that includes a first surface and a second surface that is provided opposite to the first surface, the optical element receiving light emitted from the display surface through the first surface, reflecting the light off the second surface in a direction different from a direction toward the display surface, and emitting the light from the first surface; and a casing that houses the display element and the optical element, wherein the first surface and the second surface are concave surfaces that are concave in a direction of incidence of the light, when the optical element placed such that a height direction of the optical element matches a vertical direction is viewed in a cross section including the vertical direction, t1/t2 is defined as a thickness ratio, where t1 represents a first thickness that is a thickness of the optical element at an upper end of the optical element in a reference direction that is parallel to a normal line from an origin of the second surface, and t2 represents a second thickness that is a thickness of the optical element at a lower end of the optical element in the reference direction, (i) based on a correlation between the thickness ratio and a width of the display element in a width direction perpendicular to a plane that includes the height direction and the reference direction, a value of the thickness ratio at which the width of the display element is equal to a width of the optical element is defined as an upper limit of the thickness ratio, (ii) based on a correlation between the thickness ratio and a depth of the casing in a depth direction perpendicular to a plane that includes the height direction and the width direction, a value of the thickness ratio that is equal to the depth of the casing when the thickness ratio is equal to the upper limit, and less than the upper limit is defined as a lower limit of the thickness ratio, and the thickness ratio satisfies a relationship of greater than or equal to the lower limit and less than or equal to the upper limit.

With the display device according to the present disclosure, it is possible to improve upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic diagram showing a display device according to Embodiment 1 installed in a vehicle.

FIG. 2 is a schematic diagram showing an overall configuration of the display device according to Embodiment 1.

FIG. 3 is an illustrative diagram showing a relationship between an optical element and a display surface according to Embodiment 1.

FIG. 4 is an illustrative diagram showing a relationship between an optical element and a display surface according to a comparative example.

FIG. 5 is a correlation diagram showing a correlation between the thickness ratio of the optical element and the width of a display element according to Embodiment 1.

FIG. 6 is a correlation diagram showing a correlation between the thickness ratio of the optical element and the depth of a casing according to Embodiment 1.

FIG. 7 is a schematic diagram showing an overall configuration of a display device according to Embodiment 2.

FIG. 8 is a schematic diagram showing an overall configuration of a display device according to Embodiment 3.

FIG. 9 is a schematic diagram showing an overall configuration of a display device according to Embodiment 4.

FIG. 10 is a perspective view of an optical element according to Embodiment 5.

FIG. 11 is a front view of an optical element according to Embodiment 6.

FIG. 12 is a configuration diagram of an optical element according to Embodiment 7.

### DESCRIPTION OF EMBODIMENTS

Here, conventionally, there has been a demand for reducing the size of the display device as described in PTL 1. Accordingly, the present disclosure provides a display device in which it is possible to achieve size reduction.

A display device according to an aspect of the present disclosure includes: a display element that includes a display surface; an optical element that includes a first surface and a second surface that is provided opposite to the first surface, the optical element receiving light emitted from the display surface through the first surface, reflecting the light off the second surface in a direction different from a direction toward the display surface, and emitting the light from the first surface; and a casing that houses the display element and the optical element, wherein the first surface and the second surface are concave surfaces that are concave in a direction of incidence of the light, when the optical element placed such that a height direction of the optical element matches a vertical direction is viewed in a cross section including the vertical direction, t1/t2 is defined as a thickness ratio, where t1 represents a first thickness that is a thickness of the optical element at an upper end of the optical element in a reference direction that is parallel to a normal line from an origin of the second surface, and t2 represents a second thickness that is a thickness of the optical element at a lower end of the optical element in the reference direction, (i) based on a correlation between the thickness ratio and a width of the display element in a width direction perpendicular to a plane that includes the height direction and the reference direction, a value of the thickness ratio at which the width of the display element is equal to a width of the optical element is defined as an upper limit of the thickness ratio, (ii) based on a correlation between the thickness ratio and a depth of the casing in a depth direction perpendicular to a plane that includes the height direction and the width direction, a value of the thickness ratio that is equal to the depth of the casing when the thickness ratio is equal to the upper limit, and less than the upper limit is defined as a lower limit of the thickness ratio, and the thickness ratio satisfies a relationship of greater than or equal to the lower limit and less than or equal to the upper limit.

With this configuration, the width of the display element can be made comparable with or less than the width of the optical element without increasing the effective display region of the display element. That is, it is possible to suppress an increase in the size of the display element. Furthermore, it is also possible to suppress an excessive increase in the depth of the casing that is the spacing extending from the optical element to the light emitter of the casing. Accordingly, the size of the display device as a whole can be reduced.

In the display device according to the aspect of the present disclosure, the thickness ratio may satisfy a relationship of 0.5 or more and 4.0 or less.

With this configuration, the range of the thickness ratio (t1/t2) in which it is possible to suppress an increase in the size of the display element and an increase in the depth of the casing is determined, and it is therefore possible to obtain a specific design guideline for size reduction.

The display device according to the aspect of the present disclosure may include a mirror that is provided at an opposing position to the display surface and the first surface.

With this configuration, a mirror is provided at an opposing position to the display surface of the display element and the first surface of the optical element, and it is therefore possible to reflect the light emitted from the display surface by the mirror and cause the light to be incident on the optical element through the first surface. It is thereby possible to increase the optical path length while suppressing an increase in the size of the display device.

In the display device according to the aspect of the present disclosure, the mirror may be a flat mirror.

With this configuration, a flat mirror that is easy to produce is used as the mirror, and it is therefore possible to increase the optical path length while suppressing the production cost.

The display device according to the aspect of the present disclosure may include a half mirror that is provided between the mirror and the optical element.

With this configuration, a half mirror is provided between the mirror and the optical element. Accordingly, the light emitted from the display surface can be reflected off by the half mirror to guide the light to the mirror, and cause the light reflected off by the mirror to transmit through the half mirror, and then to be reflected off by the optical element and then reflected off by the half mirror. It is thereby possible to further increase the optical path length.

In the display device according to the aspect of the present disclosure, as viewed in a front view of the optical element, a lower side of the optical element may have a curved shape that protrudes downward.

With this configuration, the lower side of the optical element has a curved shape that protrudes downward, and thus the size of the effective display region of the display element can be reduced. Accordingly, the size of the display element can be reduced, and the size of the display device can be further reduced.

In the display device according to the aspect of the present disclosure, the display element may have a curved plate shape that conforms to the curved shape of the lower side of the optical element, and may be provided at an opposing position to the lower side of the optical element.

With this configuration, the display element has a curved plate shape that conforms to the curved shape of the lower side of the optical element, and thus the display element can be placed along the lower side of the optical element. It is thereby possible to suppress a dead space, and further reduce the size of the display device.

In the display device according to the aspect of the present disclosure, the optical element may be right-left symmetric in a state in which the optical element is placed such that the height direction of the optical element matches the vertical direction.

With this configuration, the optical element is right-left symmetric, and it is therefore possible to suppress a distortion in an image in the right left direction (width direction).

In the display device according to the aspect of the present disclosure, in the optical element, a surface excluding the first surface and the second surface may include a first light absorber that absorbs more light than the first surface and the second surface.

With this configuration, a surface of the optical element excluding the first surface and the second surface of the optical element includes a first light absorber, and it is therefore possible to suppress reflection of light at and transmission of light through the surface excluding the first surface and the second surface. It is thereby possible to suppress emission of light at unnecessary areas, and enhance image quality.

In the display device according to the aspect of the present disclosure, the first surface may be smaller in area than the second surface. The first surface may include, in a peripheral edge of the first surface excluding a region of the optical element that corresponds to an effective display region of the display element, a second light absorber that absorbs more light than the region of the optical element. The second light absorber may be sized to surround the second surface as viewed in a front view of the optical element.

With this configuration, in the peripheral edge of the first surface excluding a region of the optical element that corresponds to the effective display region of the display element, a second light absorber that is sized to surround the second surface is provided, and it is therefore possible to suppress emission of light at the periphery of the first surface or the second surface.

In the display device according to the aspect of the present disclosure, as viewed in a front view of the optical element, a width of the optical element at the lower end of the optical element may be less than a width of the optical element at the upper end of the optical element, and the upper limit of the thickness ratio is a value of the thickness ratio at which the width of the display element may be equal to the width of the optical element at the lower end of the optical element.

With this configuration, the width of the display element can be made smaller than the width of the optical element on the lower side (at the lower end) of the optical element when the optical element in a front view is turned upside down in an inverted trapezoid shape. Accordingly, it is possible to further suppress an increase in the size of the display element, and thus the size of the display device as a whole can be further reduced.

In the display device according to the aspect of the present disclosure, the thickness ratio may be less than or equal to 1.7.

With this configuration, the upper limit of the thickness ratio (t1/t2) with which it is possible to further suppress an increase in the size of the display element is determined, and it is therefore possible to obtain a more specific design guideline for size reduction.

In the display device according to the aspect of the present disclosure, the second surface may include a frame.

With this configuration, a difference in viewing distance is generated between an image emitted from the display device and the frame, and it is therefore possible to view the image with increased depth.

In the display device according to the aspect of the present disclosure, the first surface of the optical element may include anti-reflection means.

With this configuration, reflection at the first surface is suppressed by the anti-reflection means, and thus the driver can easily view the virtual image.

### EMBODIMENTS

The embodiments described below show specific examples of the present disclosure. The numerical values, shapes, materials, structural elements, the arrangement and connection of the structural elements, and the like shown in the embodiments given below are merely examples, and therefore are not intended to limit the scope of the present disclosure. Also, among the structural elements described in the embodiments given below, structural elements not recited in any one of the independent claims are described as arbitrary structural elements.

In the embodiments given below, the terms indicating a relative orientation of two directions such as “parallel” and “perpendicular” may be used. However, these terms may also encompass orientations other than the strict meaning of the orientation. For example, unless otherwise stated, the expression “two directions are parallel” not only means that the two directions are completely parallel, but also means that the two directions are substantially parallel, or in other words, for example, a deviation of about several percent may be included.

Optical paths shown in the diagrams that are referred to when describing the embodiments below are illustrated to indicate the basic concept, and therefore do not necessarily reflect the actual optical paths.

In the description given below and the diagrams, the width direction or the right left direction of an optical element is defined as X axis direction, the height direction or the vertical direction of the optical element is defined as Y axis direction, and a direction that is perpendicular to both the X axis direction and the Y axis direction is defined as Z axis direction. The Z axis direction corresponds to the depth direction of a casing, which will be described later. In the description given below, the term “X-axis plus direction” refers to an arrow direction extending along the X axis, and the term “X-axis minus direction” refers to a direction opposite to the X-axis plus direction. The term “X axis direction” when used alone refers to both or either one of the X-axis plus direction and the X-axis minus direction. The same applies to the Y axis direction and the Z axis direction.

### Embodiment 1

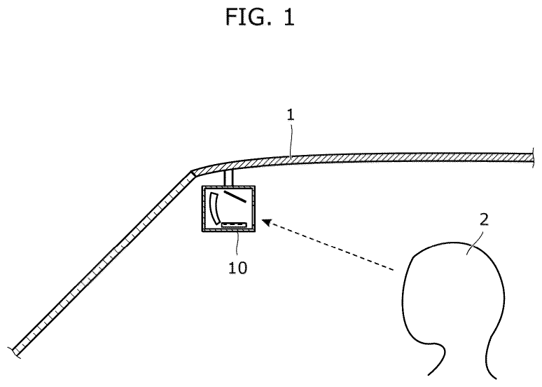

FIG. 1 is a schematic diagram showing display device 10 according to Embodiment 1 installed in vehicle 1. In FIG. 1, vehicle 1 and casing 20 are shown in cross section.

As shown in FIG. 1, display device 10 is a device for displaying images. In the present embodiment, display device 10 is installed in the vehicle cabin of vehicle 1. For example, display device 10 displays images captured by a camera for capturing images of the rear view of vehicle 1. Accordingly, driver 2 of vehicle 1 can visually recognize the state of the rear of vehicle 1 by looking at display device 10 (see a broken arrow shown in FIG. 1).

For example, display device 10 may display images showing the vehicle speed of vehicle 1, a detection result upon detection of an object approaching vehicle 1, navigation information for navigating vehicle 1 from the current location of vehicle 1 to the target destination, and the like.

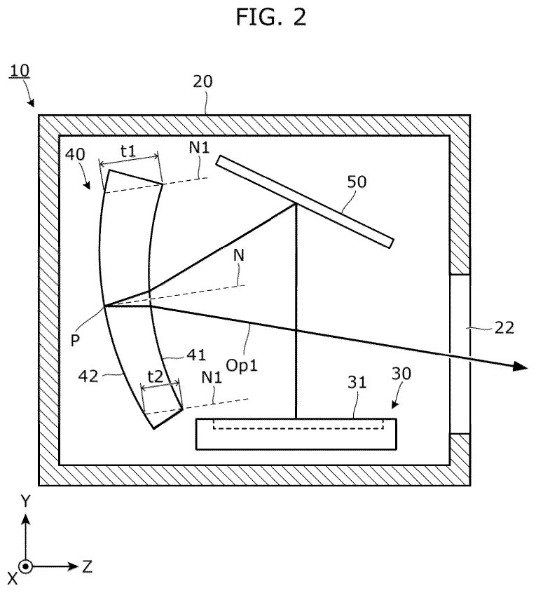

FIG. 2 is a schematic diagram showing an overall configuration of display device 10 according to Embodiment 1. In FIG. 2, casing 20 is shown in cross section. As shown in FIG. 2, display device 10 includes casing 20, display element 30, optical element 40, and mirror 50.

Casing 20 houses display element 30, optical element 40, and mirror 50. In the present embodiment, casing 20 is suspended from the ceiling of vehicle 1. Casing 20 includes light emitter 22 for emitting light emitted from display element 30 to the outside of casing 20. Light emitter 22 is a through hole through which the interior space and the exterior space of casing 20 communicate with each other. In casing 20, mirror 50 is provided near a corner of casing 20 in the Y-axis plus direction relative to light emitter 22, optical element 40 is provided near an inner surface of casing 20 in the Z-axis minus direction, and display element 30 is provided at an opposing position to mirror 50 in the Y-axis minus direction and near a bottom surface of casing 20.

Display element 30 has display surface 31, and emits light that represents an image from display surface 31. For example, display surface 31 emits light that represents an image captured by a camera for capturing images of the rear view of vehicle 1. For example, display element 30 is implemented by a liquid crystal display (LCD), an organic electro electroluminescent (EL) display, or a micro light emitting diode (LED) display, or the like. Display element 30 is configured such that display surface 31 is flat as a whole. Display element 30 is placed at an orientation that the light emitted from display surface 31 travels toward mirror 50.

Mirror 50 is a flat mirror, and provided at an opposing position to display surface 31 of display element 30 and first surface 41 of optical element 40. Specifically, mirror 50 is placed at an orientation that mirror 50 reflects the light emitted from display surface 31 toward first surface 41. With this configuration, it is possible to increase the optical path length of optical path Op1 of the light.

Next, optical element 40 will be described in detail. As shown in FIG. 2, optical element 40 includes first surface 41 and second surface 42 that are provided opposite to each other, and is formed from a light-transmitting material such as a light-transmitting resin (for example, polymethyl methacrylate (PMMA), polycarbonate (PC), cyclic olefin copolymer (COC), cyclic olefin polymer (COP), or the like) or glass. Optical element 40 is placed at an orientation that first surface 41 receives the light from mirror 50. Accordingly, the light from display surface 31 is reflected off by mirror 50 and incident on optical element 40 through first surface 41, then reflected off by second surface 42 in a direction different from a direction toward display surface 31, and emitted from first surface 41 toward light emitter 22 (see optical path Op1 of the light shown as an example in FIG. 2). Also, in FIG. 2, optical element 40 is placed at an orientation that the height direction of optical element 40 matches the vertical direction. It is sufficient that optical element 40 is placed at an orientation that the height direction of optical element 40 extends along the vertical direction. That is, the height direction of optical element 40 does not necessarily need to completely match the vertical direction, and there may be a deviation of about several percent.

As shown in FIG. 2, first surface 41 and second surface 42 of optical element 40 are concave surfaces that are concave in a direction away from mirror 50, or in other words, smooth concave surfaces that are concave in the direction of incidence of the light. Specifically, each of first surface 41 and second surface 42 is a freeform surface that uses a polynomial function or the like.

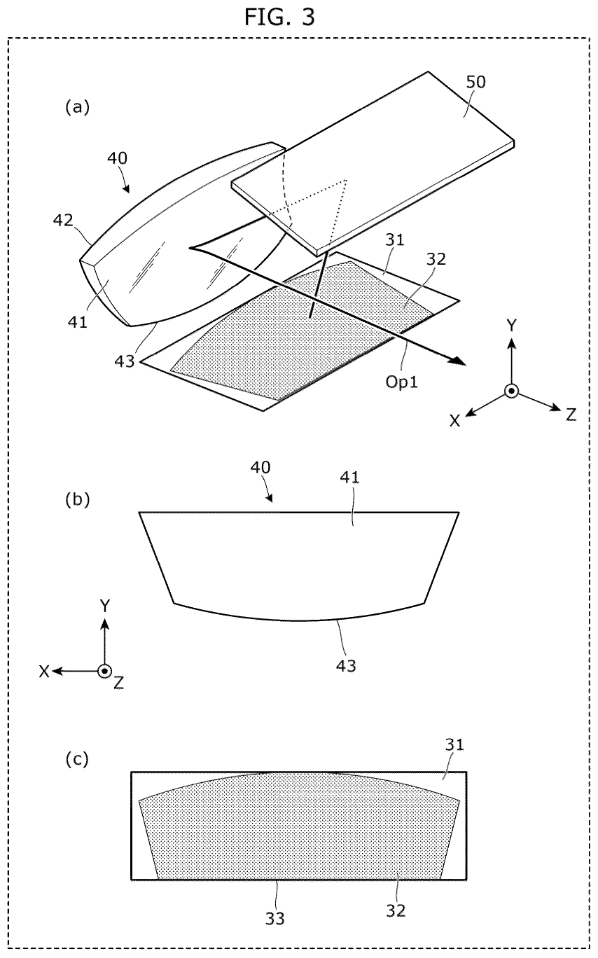

FIG. 3 is an illustrative diagram showing a relationship between optical element 40, display surface 31, and mirror 50 according to Embodiment 1. (a) in FIG. 3 is a perspective view of optical element 40, display surface 31, and mirror 50, (b) in FIG. 3 is a front view of optical element 40, and (c) in FIG. 3 is a front view of display surface 31 and shows effective display region 32 of display surface 31 that corresponds to optical element 40. In (c) in FIG. 3, effective display region 32 is hatched with dots.

As shown in (a) in FIG. 3, optical element 40 has a thickness smaller than the width and the height of optical element 40 as viewed in a front view of first surface 41. Also, as shown in (b) in FIG. 3, optical element 40 has a right-left symmetric shape as viewed in a front view of the optical element. Specifically, optical element 40 has an inverted trapezoid shape that is elongated in the X axis direction as viewed in a front view of the optical element, with lower side 43 of optical element 40 having a curved shape that protrudes downward.

As described above, first surface 41 and second surface 42 of optical element 40 are concave surfaces. For this reason, as shown in (c) in FIG. 3, effective display region 32 of display surface 31 that is provided to oppose optical element 40 has a vertically inverted shape of the shape of optical element 40 when optical element 40 in a front view is turned upside down, with one long side 33 being linear.

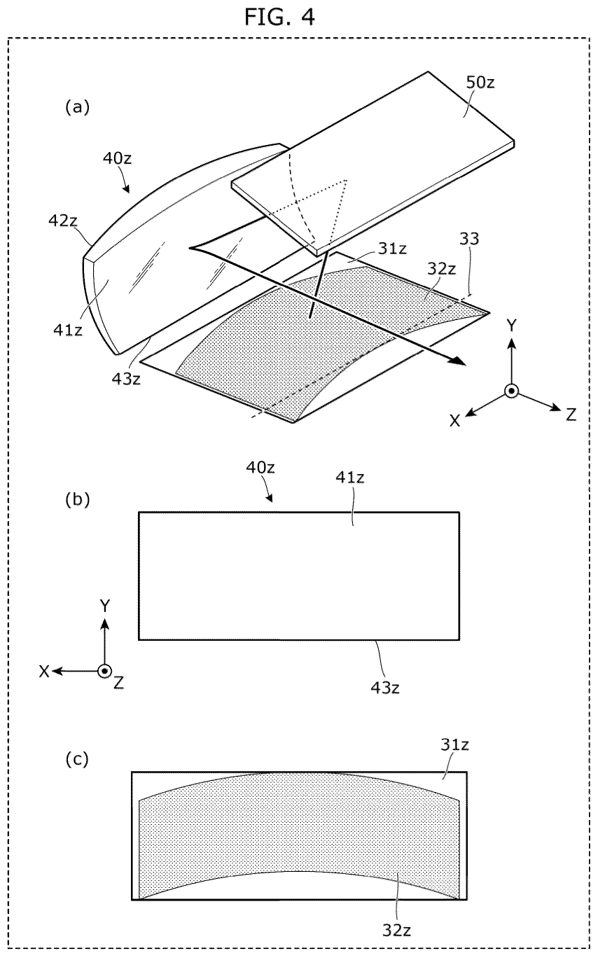

Here, as a comparative example, optical element 40z that has a rectangular shape as viewed in a front view of the optical element will be described. FIG. 4 is an illustrative diagram showing a relationship between optical element 40z, display surface 31z, and mirror 50z according to the comparative example. (a) in FIG. 4 is a perspective view of optical element 40z, display surface 31z, and mirror 50z, (b) in FIG. 4 is a front view of optical element 40z, and (c) in FIG. 4 is a front view of display surface 31z and shows effective display region 32z of display surface 31z that corresponds to optical element 40z. In (c) in FIG. 4, effective display region 32z is hatched with dots.

As shown in (b) in FIG. 4, optical element 40z has a rectangular shape that is elongated in the X axis direction as viewed in a front view of the optical element. Accordingly, lower side 43z of optical element 40z is linear. In optical element 40z as well, each of first surface 41z and second surface 42z is a freeform surface as described above. For this reason, as shown in (c) in FIG. 4, effective display region 32z of display surface 31z that is provided to oppose optical element 40z has a curved shape, with a pair of longer sides protruding in the same direction. (a) in FIG. 4, a line that corresponds to long side 33 of effective display region 32 according to the embodiment is indicated by a broken line. As described above, effective display region 32z according to the comparative example has an area larger than that of effective display region 32, and thus the display element according to the comparative example is also large. In other words, display element 30 according to the embodiment can be made smaller than the display element according to the comparative example.

Next, the thickness of optical element 40 will be described. As shown in FIG. 2, the origin of a function expression that represents a freeform surface that forms second surface 42 is defined as reference position P, and a direction parallel to normal line N of second surface 42 at reference position P is defined as reference direction N1. A length of optical element 40 that extends along reference direction N1 at an upper end of optical element 40 is defined as first thickness t1, and a length of optical element 40 that extends along reference direction N1 at a lower end of optical element 40 is defined as second thickness t2. In optical element 40, the thickness of optical element 40 at any position between the upper end and the lower end of optical element 40 is within the range of first thickness t1 and second thickness t2. In optical element 40, the thickness of optical element 40 at every position of optical element 40 is smaller than the height and the width of optical element 40. In the present embodiment, an example is shown in which the origin of a function expression that represents a freeform surface that forms second surface 42 is defined as reference position P, but the center of second surface 42 as viewed in a front view of the optical element may also be defined as reference position P.

Here, with respect to a ratio (t1/t2) between first thickness t1 and second thickness t2, a simulation is performed to see how the width of display element 30 varies. The ratio (t1/t2) will also be referred to as “thickness ratio”. When the thickness ratio is greater than 1, or in other words, when t1>t2, the upper end is thicker than the thickness at the lower end. When the thickness ratio is less than 1, or in other words, when t2>t1, the lower end is thicker than the thickness at the upper end.

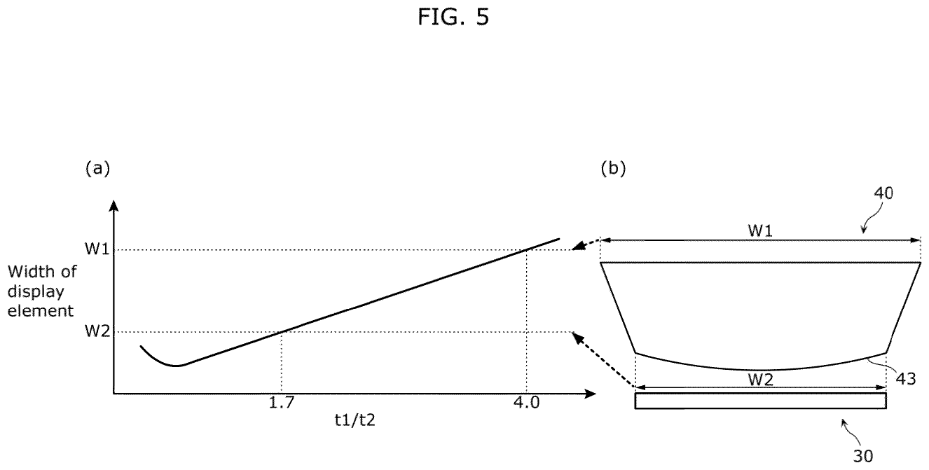

FIG. 5 is a correlation diagram showing a correlation between the thickness ratio of optical element 40 and the width of display element 30 according to Embodiment 1. That is, FIG. 5 shows a result of simulation performed to see how the width of display element 30 required to display all images on display surface 31 when the thickness ratio is changed varies. Specifically, (a) in FIG. 5 shows the result of simulation, and (b) in FIG. 5 shows a positional relationship between display element 30 and optical element 40. In (a) in FIG. 5, the horizontal axis indicates the thickness ratio (t1/t2), and the vertical axis indicates the width of display element 30. As used herein, the term “the width of display element 30” refers to a length in a width direction perpendicular to a plane that includes the height direction (the Y axis direction) and reference direction N1, or in other words, a length of display element 30 in the X axis direction.

It can be seen from FIG. 5 that there is a substantially positive correlation between the thickness ratio and the width of display element 30, and the width of display element 30 tends to increase slightly when the thickness ratio is smaller.

Here, it is found out from the result of simulation shown in (a) in FIG. 5 that, when the thickness ratio is less than or equal to 4, the width of display element 30 is smaller than width W1 of optical element 40 on the upper side (at the upper end). That is, it can be seen that, by setting the thickness ratio to a value less than or equal to 4, the width of display element 30 can be made smaller than width W1 of optical element 40 on the upper side (at the upper end). Furthermore, it is found out that, when the thickness ratio is less than or equal to 1.7, the width of display element 30 is smaller than width W2 of optical element 40 on lower side 43 (at the lower end). That is, by setting the thickness ratio to a value less than or equal to 1.7, the width of display element 30 can be made smaller than width W2 of optical element 40 on lower side 43 (at the lower end), from which it can be seen that, in terms of size reduction, it is more preferable to set the thickness ratio to a value less than or equal to 1.7. Here, it is to be noted that the terms “upper side” and “upper end” of optical element 40 refer to the same portion, and the terms “lower side” and “lower end” of optical element 40 also refer to the same portion. In particular, in the front view of optical element 40 shown in (b) in FIG. 5, lower side 43 has a convex shape that gently curves downward, and entire lower side 43 that has this shape is also referred to as “lower end”.

From the foregoing, based on the correlation between the thickness ratio and the width of display element 30 in the width direction perpendicular to a plane that includes the height direction and reference direction N1, a value (=4.0) of the thickness ratio at which the width of display element 30 is equal to the width of optical element 40 (at the upper end in (b) in FIG. 5) is defined as the upper limit of the thickness ratio.

It is more desirable that, as viewed in a front view of optical element 40, width W2 of optical element 40 at the lower end (on lower side 43) is set to be smaller than width W1 of optical element 40 at the upper end (on the upper side), and the upper limit of the thickness ratio is set to a value (=1.7) of the thickness ratio at which the width of display element 30 is equal to width W2 of optical element 40 at the lower end (on lower side 43), because it is possible to reduce the size of a portion of casing 20 for housing display element 30 that is provided to oppose lower side 43 of optical element 40.

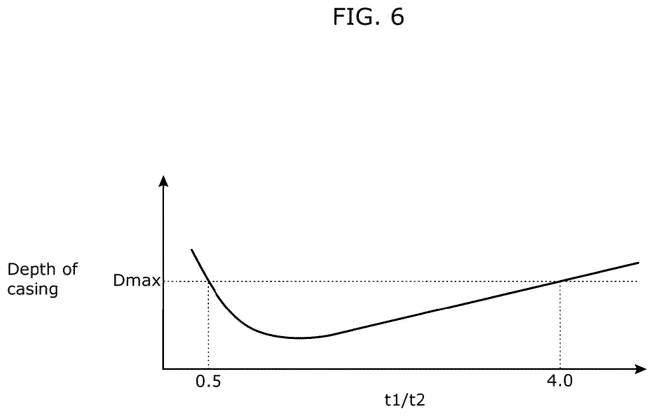

Also, a simulation was performed on a relationship between the ratio (thickness ratio) between first thickness t1 and second thickness t2 and a depth of casing 20 extending from optical element 40 to light emitter 22. The result is shown in FIG. 6. FIG. 6 is a correlation diagram showing a correlation between the thickness ratio of the optical element and the depth of the casing according to Embodiment 1. In FIG. 6, the horizontal axis indicates the thickness ratio (t1/t2), and the vertical axis indicates the depth of casing 20.

As used herein, the term “the depth of casing 20” is defined as a distance (spacing) extending from reference position P at second surface 42 of optical element 40 to light emitter 22. It is found out from FIG. 6 that, when the thickness ratio is set to a value within a range from 4 or less to about 1.3, the depth tends to decrease correspondingly as the thickness ratio decreases, but when the thickness ratio is set to a value less than or equal to 1.3, the depth tends to increase as the thickness ratio decreases. It is also found out that, when the thickness ratio is set to a value less than 0.5, the depth tends to exceed depth Dmax when the thickness ratio is 4. Accordingly, by setting the thickness ratio to a value greater than or equal to 0.5, it is possible to suppress an excessive increase in the depth of the casing.

From the foregoing, based on the correlation between the thickness ratio and the depth of casing 20 in the depth direction (the Z axis direction) perpendicular to the height direction (the Y axis direction) and the width direction (the X axis direction), a value of the thickness ratio that is equal (=Dmax) to depth Dmax of casing 20 when the thickness ratio is equal to the upper limit (=4.0), and less (=0.5) than the upper limit is defined as the lower limit of the thickness ratio.

As described above, display device 10 according to the present embodiment includes: display element 30 that has display surface 31; optical element 40 that includes first surface 41 and second surface 42 that is provided opposite to first surface 41, optical element 40 receiving light emitted from display surface 31 through first surface 41, reflecting the light off second surface 42 in a direction different from a direction toward display surface 31, and emitting the light from first surface 41; and casing 20 that houses display element 30 and optical element 40. First surface 41 and second surface 42 are concave surfaces that are concave in a direction of incidence of the light. When optical element 40 placed such that a height direction of optical element 40 matches a vertical direction is viewed in a cross section including the vertical direction, t1/t2 is defined as a thickness ratio, where t1 represents a first thickness that is a thickness of optical element 40 at an upper end of optical element 40 in reference direction N1 that is parallel to a normal line from an origin of second surface 42, and t2 represents a second thickness that is a thickness of optical element 40 at a lower end of optical element 40 in reference direction N1, (i) based on a correlation between the thickness ratio and a width of display element 30 in a width direction perpendicular to a plane that includes the height direction and reference direction N1, a value of the thickness ratio at which the width of display element 30 is equal to the width of optical element 40 is defined as an upper limit of the thickness ratio, (ii) based on a correlation between the thickness ratio and a depth of casing 20 in a depth direction perpendicular to a plant that includes the height direction and the width direction, a value of the thickness ratio that is equal to depth Dmax of casing 20 when the thickness ratio is equal to the upper limit, and less than the upper limit is defined as a lower limit of the thickness ratio, and the thickness ratio satisfies a relationship of greater than or equal to the lower limit and less than or equal to the upper limit.

With this configuration, the width of display element 30 can be made comparable with or less than the width of optical element 40 without enlarging the effective display region of display element 30. That is, it is possible to suppress an increase in the size of display element 30. Furthermore, it is also possible to suppress an excessive increase in the depth of casing 20 that is the spacing extending from optical element 40 to light emitter 22 of casing 20. Accordingly, the size of the display device as a whole can be reduced.

Also, in display device 10, the thickness ratio satisfies a relationship of 0.5 or more and 4.0 or less.

With this configuration, the range of the thickness ratio in which it is possible to suppress an increase in the size of display element 30 and an increase in the depth of casing 20 is determined, and thus a specific design guideline for size reduction can be obtained.

Also, display device 10 includes mirror 50 that is provided at an opposing position to display surface 31 and first surface 41. With this configuration, mirror 50 is provided at an opposing position to display surface 31 of display element 30 and first surface 41 of optical element 40, and it is therefore possible to reflect the light emitted from display surface 31 by mirror 50 and cause the light to be incident on optical element 40 through first surface 41. It is thereby possible to increase the optical path length while suppressing an increase in the size of the display device.

Also, mirror 50 is a flat mirror. With this configuration, a flat mirror that is easy to produce is used as mirror 50, and it is therefore possible to increase the optical path length while suppressing the production cost.

Also, as viewed in a front view of optical element 40, lower side 43 of optical element 40 has a curved shape that protrudes downward.

With this configuration, lower side 43 of optical element 40 has a curved shape that protrudes downward, and thus the size of the effective display region of display element 30 can be reduced. Accordingly, the size of display element 30 can be reduced, and the size of the display device can be further reduced.

Also, optical element 40 is right-left symmetric in a state in which optical element 40 is placed such that the height direction of optical element 40 matches the vertical direction.

With this configuration, optical element 40 is right-left symmetric, and it is therefore possible to suppress a distortion in an image in the right left direction (width direction).

Also, in display device 10, as viewed in a front view of optical element 40, a width of optical element 40 at the lower end of optical element 40 is less than a width of optical element 40 at the upper end of optical element 40, and the upper limit of thickness ratio t1/t2 is a value of thickness ratio t1/t2 at which the width of display element 30 is equal to the width of optical element 40 at the lower end of optical element 40.

With this configuration, the width of display element 30 can be made smaller than the width of optical element 40 on lower side 43 of optical element 40 when optical element 40 in the front view described above is turned upside down in an inverted trapezoid shape. Accordingly, it is possible to further suppress an increase in the size of display element 30, and thus the size of the display device as a whole can be further reduced.

Also, in display device 10, the thickness ratio is less than or equal to 1.7.

With this configuration, the upper limit of the thickness ratio with which it is possible to further suppress an increase in the size of display element 30 is determined, and it is therefore possible to obtain a more specific design guideline for size reduction.

In Embodiment 1, an example is shown in which lower side 43 of optical element 40 has a curved shape that protrudes downward, but the lower side of the optical element may be linear, or may have a curved shape that protrudes upward.

Also, in Embodiment 1, an example is shown in which mirror 50 is a flat mirror, but mirror 50 may be a curved mirror.

### Embodiment 2

Next, display device 10A according to Embodiment 2 will be described. In the description given below, structural elements that are the same as those of the embodiment are given the same reference numerals, and a description thereof may be omitted.

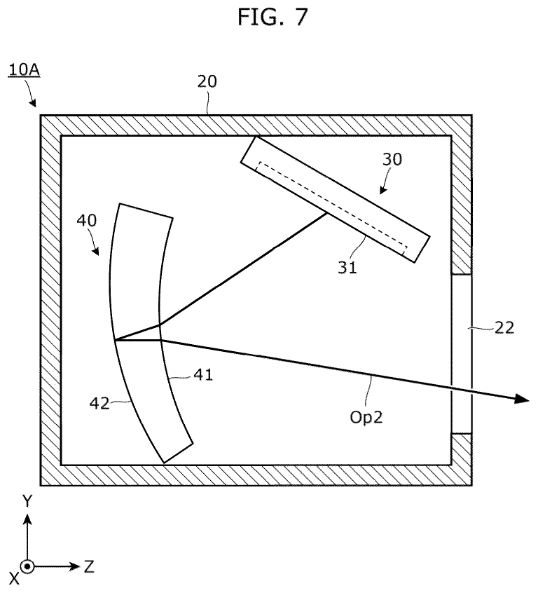

FIG. 7 is a schematic diagram showing an overall configuration of display device 10A according to Embodiment 2. Specifically, FIG. 7 is a diagram that corresponds to FIG. 2. As shown in FIG. 7, display device 10A includes casing 20, display element 30, and optical element 40, but does not include mirror 50. In casing 20, display element 30 is provided near a corner of casing 20 in the Y-axis plus direction relative to light emitter 22, and optical element 40 is provided near an inner surface of casing 20 in the Z-axis minus direction.

With the configuration described above, it is unnecessary to provide mirror 50 on optical path Op2, and it is therefore possible to simplify the structure.

### Embodiment 3

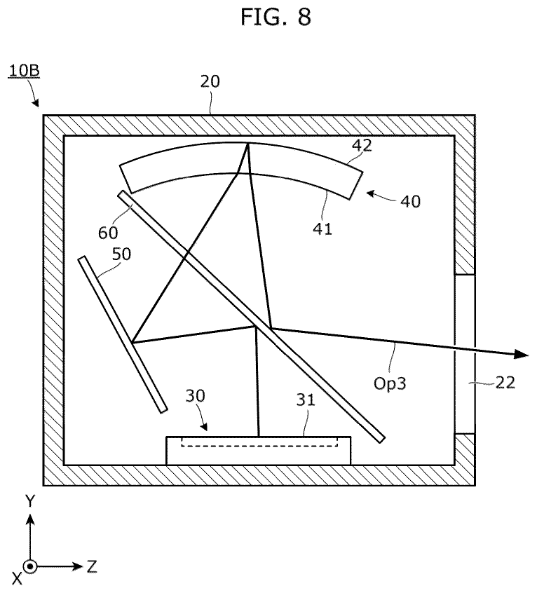

Next, display device 10B according to Embodiment 3 will be described. FIG. 8 is a schematic diagram showing an overall configuration of display device 10B according to Embodiment 3. Specifically, FIG. 8 is a diagram that corresponds to FIG. 2.

As shown in FIG. 8, display device 10B includes casing 20, display element 30, optical element 40, mirror 50, and half mirror 60. In casing 20, mirror 50 is provided near an inner surface of casing 20 in the Y-axis minus direction, display element 30 is provided near a bottom surface of casing 20 at a position in the Z-axis plus direction relative to mirror 50, and optical element 40 is provided near a top surface of casing 20 at a position in the Z-axis plus direction relative to mirror 50. Optical element 40 is placed at an orientation that first surface 41 and second surface 42 protrude toward the top surface of casing 20. Also, in casing 20, half mirror 60 is provided between display element 30 and optical element 40. Half mirror 60 is placed at an orientation that half mirror 60 reflects light emitted from display element 30, transmits the light reflected off by mirror 50 through half mirror 60, and reflects the light reflected off by optical element 40. Accordingly, the light emitted from display surface 31 of display element 30 is reflected off by half mirror 60, then reflected off by mirror 50, thereafter transmitted through half mirror 60, reflected off by optical element 40, then reflected off by half mirror 60, and emitted from light emitter 22. With this configuration, it is possible to further increase the optical path length of optical path Op3 of the light.

As described above, display device 10B according to Embodiment 3 includes half mirror 60 that is provided between mirror 50 and optical element 40. Accordingly, the light emitted from display surface 31 can be guided to mirror 50 by being reflected off by half mirror 60, and the light reflected off by mirror 50 can be transmitted through half mirror 60, then reflected off by optical element 40, and reflected off by half mirror 60. It is thereby possible to further increase the optical path length.

Here, half mirror 60 may be configured by placing a reflective polarizing plate and a λ/4 retardation plate on a glass substrate (in this case, the reflective polarizing plate is placed on a surface of the glass substrate on display element 30 side, and the λ/4 retardation plate is placed on a surface of the glass substrate on optical element 40 side). Also, λ/4 retardation plate may be placed on mirror 50. With this configuration, in the case where display element 30 that includes a polarizing plate on display surface 31 is used, the light emitted from display element 30 can be efficiently guided to driver 2.

### Embodiment 4

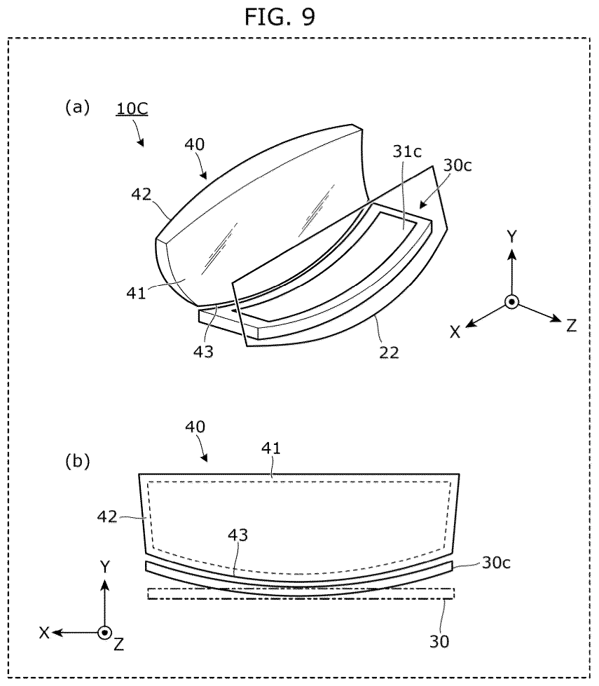

Next, display device 10C according to Embodiment 4 will be described. FIG. 9 is a schematic diagram showing an overall configuration of display device 10C according to Embodiment 4. Specifically, (a) in FIG. 9 is a perspective view of optical element 40 and display element 30c that are included in display device 10C, and (b) in FIG. 9 is a front view of optical element 40 and display element 30c. In (a) in FIG. 9, light emitter 22 of casing 20 is also illustrated. In FIG. 9, an illustration of mirror 50 is omitted for the sake of understanding of the drawing.

As shown in FIG. 9, display element 30c has a curved plate shape that conforms to the curved shape of lower side 43 of optical element 40, and is provided at an opposing position to lower side 43 of optical element 40. Accordingly, display surface 31c of display element 30c also has a curved shape. For example, in (b) in FIG. 9, flat display element 30 is indicated by a dashed-double-dotted line. In the case where flat display element 30 is used, opposing ends of flat display element 30 in the X axis direction are spaced apart from optical element 40 with a spacing therebetween, and the spacing serves as a dead space. On the other hand, in the case where curved display element 30c is used, display element 30c can be placed along lower side 43 of optical element 40, and thus the dead space can be suppressed.

As described above, in display device 10C according to Embodiment 4, display element 30c has a curved plate shape that conforms to the curved shape of lower side 43 of optical element 40, and is provided at an opposing position to lower side 43 of optical element 40. With this configuration, display element 30c has a curved plate shape that conforms to the curved shape of lower side 43 of optical element 40, and thus display element 30c can be placed along lower side 43 of optical element 40. It is thereby possible to suppress the dead space, and further reduce the size of the display device.

### Embodiment 5

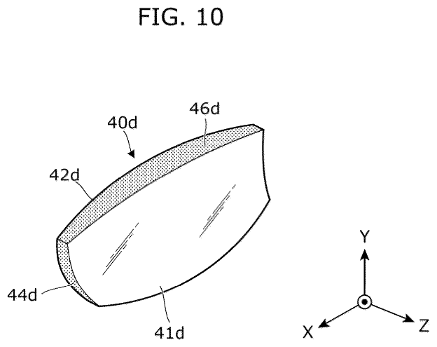

Next, optical element 40d according to Embodiment 5 will be described. FIG. 10 is a perspective view of optical element 40d according to Embodiment 5. As shown in FIG. 10, in optical element 40d, a surface (side surface 44d) excluding first surface 41d and second surface 42d includes first light absorber 46d. Specifically, side surface 44d is formed to surround first surface 41d and second surface 42d, and first light absorber 46d is provided on entire side surface 44d. In FIG. 10, first light absorber 46d is hatched with dots. First light absorber 46d is configured to absorb more light than first surface 41d and second surface 42d. Specifically, first light absorber 46d is a black layer placed on side surface 44d. With this configuration, first light absorber 46d absorbs light.

As described above, in optical element 40d according to Embodiment 5, a surface (side surface 44d) excluding first surface 41d and second surface 42d includes first light absorber 46d that absorbs more light than first surface 41d and second surface 42d.

With this configuration, side surface 44d of optical element 40d excluding first surface 41d and second surface 42d of optical element 40d includes first light absorber 46d, and it is therefore possible to suppress reflection of light at and transmission of light through side surface 44d. It is thereby possible to suppress emission of light at unnecessary areas, and enhance image quality.

First light absorber 46d may have any configuration as long as it is possible to absorb more light than first surface 41d and second surface 42d. For example, first light absorber 46d may be a colored layer other than black, may be made from a light shielding sheet, or may have a surface roughness coarser than that of first surface 41d and second surface 42d.

### Embodiment 6

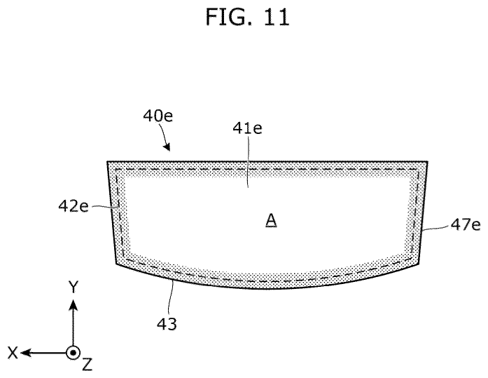

Next, optical element 40e according to Embodiment 6 will be described. FIG. 11 is a front view of optical element 40e according to Embodiment 6. In FIG. 11, the outer shape of second surface 42e is indicated by a broken line. As shown in FIG. 11, first surface 41e of optical element 40e is smaller in area than second surface 42e. Strip-shaped second light absorber 47e is provided along the entire peripheral edge of first surface 41e. In FIG. 11, second light absorber 47e is hatched with dots. Region A (first surface 41e) that is surrounded by second light absorber 47e corresponds to the effective display region of display element 30. That is, region A is where maximum image (light) emitted from display surface 31 of display element 30 is projected. Second light absorber 47e is sized to surround to second surface 42e as viewed in a front view of the optical element. Specifically, the outer shape of second surface 42e is fitted to overlap a frame that forms second light absorber 47e. Second light absorber 47e absorbs more light than region A. Specifically, second light absorber 47e is a light shielding sheet placed along the periphery of first surface 41e. With this configuration, second light absorber 47e absorbs light.

As described above, in optical element 40e according to Embodiment 6, first surface 41e is smaller in area than second surface 42e, first surface 41e includes, in a peripheral edge of first surface 41e excluding region A of optical element 40e that corresponds to the effective display region of display element 30, second light absorber 47e that absorbs more light than first surface 41e and second surface 42e, and second light absorber 47e is sized to surround second surface 42e as viewed in a front view of the optical element.

With this configuration, second light absorber 47e that is sized to surround second surface 42e is provided in the peripheral edge of first surface 41e excluding region A that corresponds to the effective display region of display element 30, and it is therefore possible to suppress emission of light at the periphery of first surface 41e or second surface 42e.

Second light absorber 47e may have any configuration as long as it is possible to absorb more light than region A. For example, second light absorber 47e may be a colored layer such as a black layer, or may have a surface roughness coarser than that of region A.

### Embodiment 7

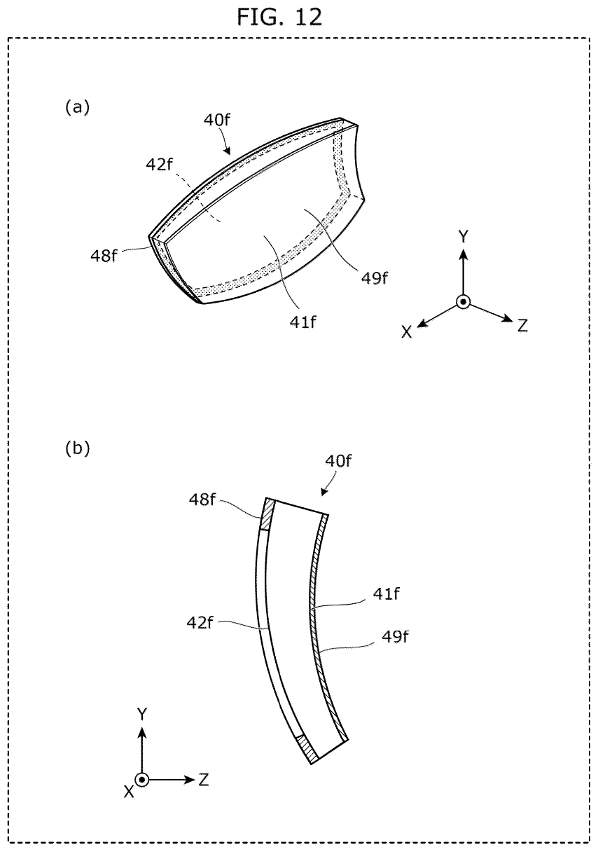

Next, optical element 40f according to Embodiment 7 will be described. FIG. 12 is a configuration diagram showing an optical element according to Embodiment 7. (a) in FIG. 12 shows a perspective view of the optical element, and (b) in FIG. 12 shows a cross-sectional view of the optical element. The perspective view shown in (a) in FIG. 12 is a view in the same direction as FIG. 10.

As shown in FIG. 12, in optical element 40f that includes first surface 41f and second surface 42f, second surface 42f includes frame 48f. FIG. 12 shows a configuration in which frame 48f is a black frame. Frame 48f has a predetermined width along an outer periphery of second surface 42f. Specifically, frame 48f is a strip-shaped light shielding sheet provided along the outer periphery of second surface 42f, and in second surface 42f, a reflection film is formed only in a region in which the light shielding sheet is not formed. With this configuration, the viewer who views an image can visually recognize the black frame in the image.

As described above, in optical element 40f according to Embodiment 7, second surface 42f includes frame 48f.

With this configuration, a difference in viewing distance is generated between an image emitted from display device 10 and frame 48f, and it is therefore possible to view the image with increased depth.

Frame 48f is not limited to a black frame. Frame 48f may have any configuration and be in any color as long as it is possible to absorb more light than region A shown in FIG. 11. For example, frame 48f may be in a dark color such as gray or dark blue. Also, for example frame 48f may be a colored layer such as a black layer, or may have a surface roughness coarser than that of region A.

Also, frame 48f is not necessarily need to be provided along the entire outer periphery of second surface 42f. For example, frame 48f may be provided along a portion of the outer periphery of second surface 42f such as only along the lower side of the optical element.

Also, as shown in FIG. 12, in optical element 40f that includes first surface 41f and second surface 42f, first surface 41f includes anti-reflection film 49f. Anti-reflection film 49f is a so-called anti reflection (AR) coating. Specifically, anti-reflection film 49f is formed by, for example, attaching an AR coating film to first surface 41f. Anti-reflection film 49f does not necessarily need to be formed by attaching an AR coating film to first surface 41f. Anti-reflection film 49f may be formed by, for example, applying an AR coating agent to first surface 41f, or through vapor deposition. Also, in optical element 40f according to Embodiment 7, first surface 41f includes anti-reflection film 49f.

With this configuration, reflection at first surface 41f is suppressed by anti-reflection film 49f, and thus driver 2 can easily view the virtual image.

Here, anti-reflection film 49f is used as an example of the anti-reflection means. However, the anti-reflection means may have any configuration as long as it is possible to prevent reflection at first surface 41f. For example, anti-reflection means may be formed by making fine irregularities in the first surface.

### Other Embodiments, etc.

Up to here, the display device according to one or more aspects of the present disclosure has been described above by way of embodiments, but the present disclosure is not limited to the embodiments given above. Other embodiments obtained by making various modifications that can be conceived by a person having ordinary skill in the art to the above embodiments as well as embodiments constructed by combining structural elements of different embodiments without departing from the scope of the present invention are also included within the scope of the one or more aspects of the present disclosure.

### Further Information about Technical Background to this Application

The disclosures of the following patent applications including specification, drawings, and claims are incorporated herein by reference in their entirety: Japanese Patent Application No. 2021-211854 filed on Dec. 27, 2021, and Japanese Patent Application No. 2022-080064 filed on May 16, 2022, and PCT

International Application No. PCT/JP2022/030665 filed on Aug. 10, 2022.

### INDUSTRIAL APPLICABILITY

The present disclosure can be used in a display device for displaying images or the like.

1. A display device comprising:
a display element that includes a display surface;
an optical element that includes a first surface and a second surface that is provided opposite to the first surface, the optical element receiving light emitted from the display surface through the first surface, reflecting the light off the second surface in a direction different from a direction toward the display surface, and emitting the light from the first surface; and
a casing that houses the display element and the optical element,
wherein the first surface and the second surface are concave surfaces that are concave in a direction of incidence of the light,
when the optical element placed such that a height direction of the optical element matches a vertical direction is viewed in a cross section including the vertical direction, t1/t2 is defined as a thickness ratio, where t1 represents a first thickness that is a thickness of the optical element at an upper end of the optical element in a reference direction that is parallel to a normal line from an origin of the second surface, and t2 represents a second thickness that is a thickness of the optical element at a lower end of the optical element in the reference direction,
(i) based on a correlation between the thickness ratio and a width of the display element in a width direction perpendicular to a plane that includes the height direction and the reference direction, a value of the thickness ratio at which the width of the display element is equal to a width of the optical element is defined as an upper limit of the thickness ratio,
(ii) based on a correlation between the thickness ratio and a depth of the casing in a depth direction perpendicular to a plane that includes the height direction and the width direction, a value of the thickness ratio that is equal to the depth of the casing when the thickness ratio is equal to the upper limit, and less than the upper limit is defined as a lower limit of the thickness ratio, and
the thickness ratio satisfies a relationship of greater than or equal to the lower limit and less than or equal to the upper limit.

2. The display device according to claim 1,
wherein the thickness ratio satisfies a relationship of 0.5 or more and 4.0 or less.

3. The display device according to claim 1, comprising:
a mirror that is provided at an opposing position to the display surface and the first surface.

4. The display device according to claim 3,
wherein the mirror is a flat mirror.

5. The display device according to claim 3, comprising:
a half mirror that is provided between the mirror and the optical element.

6. The display device according to claim 1,
wherein, as viewed in a front view of the optical element, a lower side of the optical element has a curved shape that protrudes downward.

7. The display device according to claim 6,
wherein the display element has a curved plate shape that conforms to the curved shape of the lower side of the optical element, and is provided at an opposing position to the lower side of the optical element.

8. The display device according to claim 1,
wherein the optical element is right-left symmetric in a state in which the optical element is placed such that the height direction of the optical element matches the vertical direction.

9. The display device according to claim 1,
wherein, in the optical element, a surface excluding the first surface and the second surface includes a first light absorber that absorbs more light than the first surface and the second surface.

10. The display device according to claim 1,
wherein the first surface is smaller in area than the second surface,
the first surface includes, in a peripheral edge of the first surface excluding a region of the optical element that corresponds to an effective display region of the display element, a second light absorber that absorbs more light than the region of the optical element, and
the second light absorber is sized to surround the second surface as viewed in a front view of the optical element.

11. The display device according to claim 1,
wherein, as viewed in a front view of the optical element, a width of the optical element at the lower end of the optical element is less than a width of the optical element at the upper end of the optical element, and
the upper limit of the thickness ratio is a value of the thickness ratio at which the width of the display element is equal to the width of the optical element at the lower end of the optical element.

12. The display device according to claim 11,
wherein the thickness ratio is less than or equal to 1.7.

13. The display device according to claim 1,
wherein the second surface includes a frame.

14. The display device according to claim 1,
wherein the first surface of the optical element includes anti-reflection means.
